(19) United States
(12) Patent Application Publication
(10) Pub. No.: US 2017/0195202 A1
(43) Pub. Date: Jul. 6, 2017

(54) SYSTEM AND METHOD TO PROVIDE SCREEN SHARING FOR CLIENT TERMINAL DEVICES

(71) Applicant: FUJITSU LIMITED, Kawasaki-shi (JP)

(72) Inventors: Takuya YAMASAKI, Kawasaki (JP); Tomonori YAMASHITA, Yokohama (JP)

(73) Assignee: FUJITSU LIMITED, Kawasaki-shi (JP)

(21) Appl. No.: 15/381,771

(22) Filed: Dec. 16, 2016

(30) Foreign Application Priority Data
Jan. 5, 2016 (JP) 2016-000731

(51) Int. Cl. H04L 12/26; H04L 29/06; G06F 3/14; H04L 29/08

(52) U.S. Cl. CPC H04L 43/0835; H04L 67/10; H04L 67/42; H04L 43/12; G06F 3/1454

(57) ABSTRACT

A system includes plural servers provided in a network constructed in a predetermined area, plural client terminal devices to display a screen image in accordance with a result of executing an application program that is executed by at least one of the plural servers, and a controller to control the plural servers and the plural client terminal devices. The controller acquires, from each of the plural client terminal devices, an evaluation value of a communication quality for each of a plurality of terminal-server combinations between the each client terminal and the plural servers, determines, from among the plural servers, an objective server to execute the application program, based on the acquired evaluation value, and transmits information to be used for communicating with the determined objective server, to the plural client terminal devices, and notifying the determined objective server of an execution instruction to execute the application program.

### CROSS-REFERENCE TO RELATED APPLICATION

This application is based upon and claims the benefit of priority of the prior Japanese Patent Application No. 2016-000731, filed on Jan. 5, 2016, the entire contents of which are incorporated herein by reference.

### FIELD

The embodiment discussed herein is related to system and method to provide screen sharing for client terminal devices.

### BACKGROUND

In the related art, there is a technique called a screen sharing system for performing a remote conference or design review while referring to a screen relating the same application program on a plurality of personal computers (PCs).

In addition, in the related art, in DaaS that is one of the utilization forms of a cloud environment, a desktop screen of a server in the cloud environment is used from a client terminal device which is operated by a user. The client terminal device displays a part of a screen of the server or all of the screen of the server and is able to perform an input operation with respect to the server. The server performs an execution of an application in accordance with the input operation.

In addition, as a related technique, for example, a technique in which for static content such as a document, an image, or a video, caches for the content are placed in various locations of a network, and a client terminal device reduces the load or delay on the network by using the nearby cache is included (for example, refer to Japanese National Publication of International Patent Application No. 2010-503901). Furthermore, for example, there is a technique in which the load on the network is reduced by duplicating information sent in the network with a router and streaming data such as a video is delivered to a lot of client terminals (for example, refer to “About Multicast Streaming”, [online], October 2007, Microsoft (registered trademark), [searched on Dec. 1, 2015], the Internet <https://technet.microsoft.com/ja-jp/libraray/cc753242.aspx>).

Furthermore, for example, there is a technique in which a data processing device manages terminal information for communicating for each terminal, and determines an image size, a coding bit rate or the like of screen information based on the terminal information (for example, refer to Japanese Laid-open Patent Publication No. 2010-141824). In addition, for example, there is a technique that in order for intermediate image information to be delivered from a transmitting terminal to a receiving terminal, a delivery server transmits a frame request of image information to the transmitting terminal, receives an image frame corresponding to the frame request from the transmitting terminal, and transmits the received image frame to the receiving terminal (for example, refer to Japanese Laid-open Patent Publication No. 2015-023466).

### SUMMARY

According to an aspect of the invention, a system includes plural servers provided in a network constructed in a predetermined area, plural client terminal devices to display a screen image in accordance with a result of executing an application program that is executed by at least one of the plural servers, and a controller to control the plural servers and the plural client terminal devices. The controller acquires, from each of the plural client terminal devices, an evaluation value of a communication quality for each of a plurality of terminal-server combinations between the each client terminal and the plural servers, determines, from among the plural servers, an objective server to execute the application program, based on the acquired evaluation value, and transmits information to be used for communicating with the determined objective server, to the plural client terminal devices, and notifying the determined objective server of an execution instruction to execute the application program.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an operation of a screen sharing system, according to an embodiment;

FIG. 2 is a diagram illustrating an example of screen sharing, according to an embodiment;

FIG. 3 is a diagram illustrating an example of screen sharing where a single server is used, according to an embodiment;

FIG. 4 is a diagram illustrating an example of screen sharing where a plurality of servers are used, according to an embodiment;

FIG. 5 is a diagram illustrating an example of different communication speeds, according to an embodiment;

FIG. 6 is a diagram illustrating an example of a screen sharing system, according to an embodiment;

FIG. 7 is a diagram illustrating an example of a hardware configuration of a client terminal device, according to an embodiment;

FIG. 8 is a diagram illustrating an example of a hardware configuration of a server, according to an embodiment;

FIG. 9 is a diagram illustrating an example of a functional configuration of a screen sharing system, according to an embodiment;

FIG. 10 is a diagram illustrating an example of an operational sequence in a case where there is a new participate request for screen sharing from a client terminal device, according to an embodiment;

FIG. 11 is a diagram illustrating an example of a participation client list, according to an embodiment;

FIG. 12 is a diagram illustrating an example of a delay time table, according to an embodiment;

FIG. 13 is a diagram illustrating an example of a mean delay time table, according to an embodiment;

FIG. 14 is a diagram illustrating an example of an operational flowchart for determining a screen shared server by a control device, according to an embodiment;

FIG. 15 is a diagram illustrating an example of a bandwidth table, according to an embodiment;

FIG. 16 is a diagram illustrating an example of a delay time point table, according to an embodiment;

FIG. 17 is a diagram illustrating an example of a bandwidth point table, according to an embodiment;

FIG. 18 is a diagram illustrating an example of a communication quality point table, according to an embodiment;

FIG. 19 is a diagram illustrating an example of a total point table, according to an embodiment;

FIG. 20 is a diagram illustrating an example of an operational flowchart for determining a screen shared server by a control device, according to an embodiment; and

FIG. 21 is a diagram illustrating an example of an operational flowchart for determining a screen shared server by a control device, according to an embodiment.

### DESCRIPTION OF EMBODIMENT

In the related art, in a plurality of client terminal devices, there is a problem in that, in a case of screen sharing using a server, a variation in a communication delay between the server and the plurality of client terminal devices occurs. For example, when the variation in the communication delay occurs, a delay occurs in a screen display in the plurality of client terminals and it is difficult to perform collaborative work such as referring to or operating a screen in accordance with an execution of an application program by one server.

It is preferable to share a screen by suppressing the variation of the communication delay from a server for each client terminal device.

Hereinafter, a screen sharing system, a screen sharing program, and a screen sharing method according to the embodiment will be described in detail with reference to accompanying drawings.

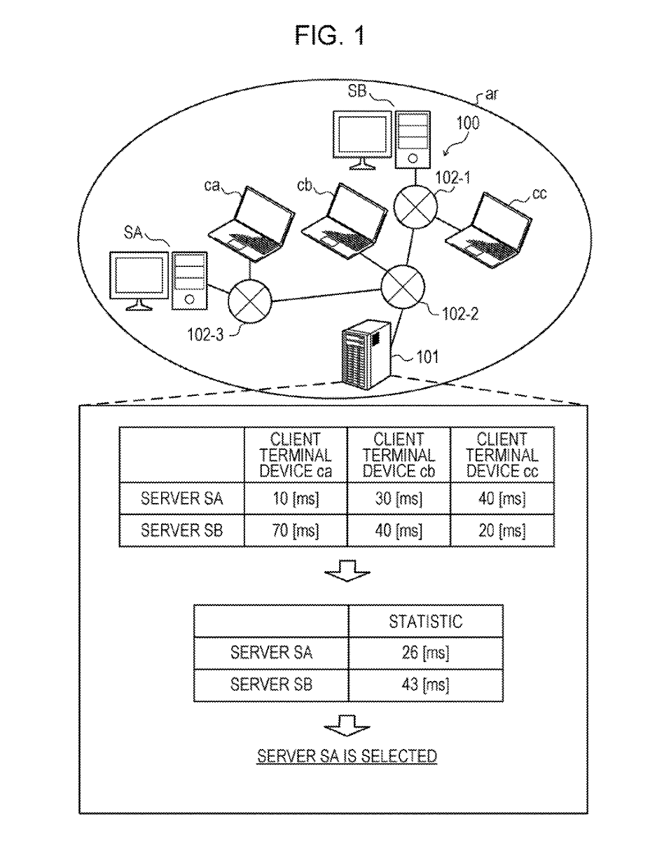

FIG. 1 is an explanatory diagram illustrating an operation example of a screen sharing system. A screen sharing system 100 in the embodiment is a system for sharing a screen by a plurality of client terminal devices in accordance with an execution of an application program to be executed by at least one server of a plurality of servers.

In the related art, there is a technique called a screen sharing system for performing a remote conference or design review while referring to a screen relating the same application program on a plurality of PCs. Hereinafter, the application program is also referred to as an application.

In addition, in the related art, in DaaS that is one of the utilization forms of a cloud environment, a desktop screen of a server in the cloud environment is used from a client terminal device which is operated by a user. The client terminal device displays a part of a screen of the server or all of the screen of the server and is able to perform an input operation with respect to the server. The server executes an application in accordance with the input operation.

Methods of the screen sharing system are broadly categorized into two types below. First, as a first type of the method, for example, one PC executes an application and the other PC displays a screen in accordance with the execution of the application. An operation with respect to the execution of the application by a participant of screen sharing is transferred to the PC in which the application is executed, and the screen changed by the operation is delivered to all of the other PCs from the PC in which the application is executed. The operation with respect to the execution of the application is, for example, an operation performed using an input device, such as a keyboard operation and a mouse operation.

Next, as a second type of the method, all of the PCs execute the same application. An operation of the application by the participant of the screen sharing is delivered to all of the PCs and is operated by synchronizing the application during execution on each PC.

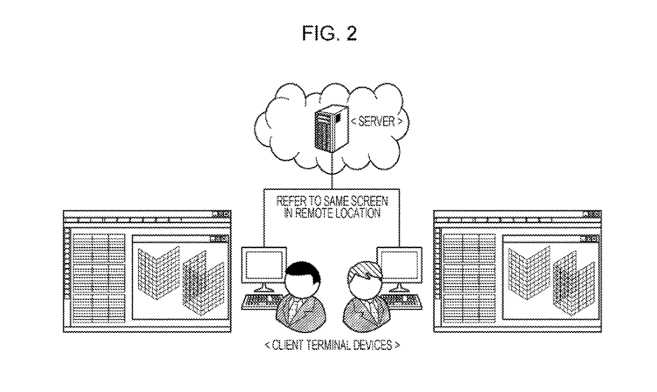

Here, in the screen sharing system to which DaaS is applied, the first type of the method is used. A detailed example will be described with reference to FIG. 2. In DaaS, a server is coupled to a single client terminal. However, in the screen sharing system 100, couplings between the plurality of client terminal devices and the server is permitted. Accordingly, a single server is able to be referred to and operated by a plurality of participants at the same time.

In the screen sharing system, screen information and operation information are transmitted and received through a network such as a local area network (LAN). The operation information is information related to user operation of an input device such as a keyboard or a mouse, and the amount of data of the operation information passing through the network is very small. On the other hand, screen information is image information of the image to be displayed on the screen of the server, and with the trend of increasing screen size and increasing resolution, the amount of data related to screen information is very large compared with the operation information.

In the screen sharing system 100, the server transmits the image information to client terminal devices so that each client terminal device displays the image information including the image of the screen of the server.

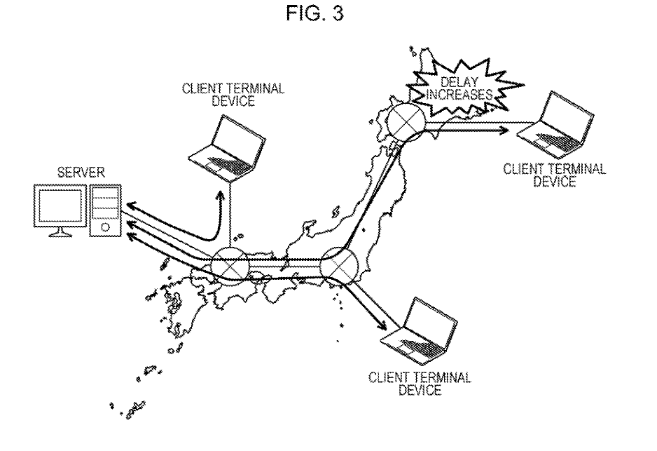

In the related art, in a plurality of client terminal devices, there is a problem in that, in a case of screen sharing using a server, a variation in a communication delay between the server and the plurality of client terminal devices occurs. For example, there is a client terminal device near the server in the network and a client terminal device far from the server in the network, in some cases. A detailed example in this case will be described with reference to FIG. 3. In such a case, a delay occurs in a screen display in the client terminal device due to the delay of the communication of the client terminal device far from the server. Therefore, it is difficult to execute collaborative work such as referring to or operating a screen in accordance with an execution of an application program by one server.

In the embodiment, a plurality of servers are dispersed and provided so that each of the client terminal devices shares a screen, and a server performing screen sharing is determined based on the evaluation value of the communication quality for each combination of the client terminal device and the server. Therefore, it is possible to suppress variation in communication delay. Accordingly, an improvement in user operability may be achieved and implementation of the collaborative work may be easily achieved.

The screen sharing system 100 includes a control device 101, a plurality of servers, and a plurality of client terminal devices.

The plurality of servers are dispersed and provided in a network which is constructed in a predetermined area ar. A network 102 may be, for example, a single network 102, or may be a plurality of networks 102. In an example of FIG. 1, the network 102 is a plurality of networks 102 such as networks 102-1 to 102-3. The predetermined area ar may be, for example, a country, a prefecture, or a plurality of countries, but is not specifically limited thereto. By assuming that the user uses the server in various locations, a developer of the system provides a plurality of servers in a dispersed manner. In the example of FIG. 1, the servers are SA and SC. An arbitrary server, such as servers SA and SB, among the plurality of servers is indicated as a “server Si” in some cases (i=A, B, . . . , or the like).

The plurality of client terminal devices are each a terminal device to be operated by a user, respectively. The plurality of client terminal devices shares a screen in accordance with an execution result of the application program to be executed by any of the plurality of servers Si. In the example of FIG. 1, the client terminal devices are ca to cc. Here, an arbitrary client terminal device, such as the client terminal devices ca to cc, among the plurality of the client terminal devices is indicated as a “client terminal device cj” in some cases (j=a, b, c, . . . , or the like).

The control device 101 controls the plurality of servers Si and the plurality of client terminal devices cj, and determines a server Si for executing the application program among the plurality of servers Si. In addition, the application program may be a program that operates in an application layer of an operating system (OS) and may be a virtual machine (VM) for operating on a hypervisor. As the application program that operates in the application layer, an application related to a business such as material creation or an e-mail, an application for handling an image such as computer aided design (CAD), and an application for handling a video are included, and the application program is not specifically limited.

Firstly, the control device 101 acquires an evaluation value of the communication quality for each of the plurality of combinations of each of the plurality of client terminal devices cj and each of the plurality of servers Si, from each of the plurality of client terminal devices cj. The evaluation value of the communication quality may be a two-way communication time for communicating between the server Si and the client terminal device cj, a bandwidth, or a packet loss rate. The two-way communication time is also referred to as a delay time. As the delay time becomes longer, the communication quality decreases. The bandwidth is an index of a data transfer speed. As the bandwidth increases, the communication quality increases. The packet loss rate is a frequency at which a packet is lost. Therefore, as the packet loss rate increases, it is evident that the communication quality decreases.

Specifically, for example, the control device 101 notifies each of the plurality of client terminal devices cj, of a measurement instruction of the evaluation value of the communication quality. For example, when each of the plurality of client terminal devices cj receives the notification of the measurement instruction, the evaluation value of the communication quality for communicating with each of the plurality of servers Si is measured. Each of the plurality of client terminal devices cj transmits the evaluation value of the communication quality which is measured for communicating with each of the plurality of servers Si to the control device 101. Next, upon receiving the evaluation value of the communication quality from the plurality of client terminal devices cj, the control device 101 acquires the evaluation value of the communication quality for each of the plurality of combinations. In the example of FIG. 1, the control device 101 acquires a delay time as the evaluation value.

The control device 101 determines which of the plurality of servers Si is to be used for executing the application program, based on the acquired evaluation value. Specifically, in the example of FIG. 1, the control device 101 determines which of the plurality of servers Si is to be used for executing the application program, based on the a statistic related to distributions of the evaluation value. Although examples of the statistic include a mean value, a center value, and the like, the mean value is exemplified in FIG. 1.

Here, the delay time indicates that as the value thereof increases, the farther away the sever is in the network 102. Therefore, the control device 101 selects the server SA having a small statistic among the servers SA and SB as the server Si for executing the application program.

In addition, in a case where the bandwidth is acquired as the evaluation value, as the value thereof decreases, the farther the server is in the network 102. In the case of the bandwidth, the statistic of the server SA becomes greater than the statistic of the server SB. Therefore, the control device 101 selects the server SA having a large statistic among the servers SA and SB as a server Si for executing the application program.

Next, the control device 101 transmits connection information to be used for coupling the determined server Si to the plurality of client terminal devices cj. In addition, the control device 101 notifies the determined server Si of an executing instruction for executing the application program. Notification of executing information means that a signal indicating the executing instruction is transmitted.

Therefore, the variation of the communication delay for each client terminal may be suppressed. Accordingly, the improvement in the operability of the user may be achieved.

FIG. 2 is an explanatory diagram illustrating an example of a screen sharing. Here, the screen sharing will be simply described. The server executes and stores the application program or data, and the client terminal device displays the image of the screen transmitted from the server as a remote desktop.

The plurality of client terminal devices include, for example, an owner client terminal device and a plurality of guest client terminal devices. For example, the owner client terminal device is able to provide the guest client terminal device with operation rights for a program executed by the server. The guest client terminal device is able to perform an operation relating to the execution of the program by receiving the operation rights from the owner client terminal device. In this manner, the collaborative work using the same screen by the plurality of users may be performed. The transmission and reception between the plurality of client terminal devices relating to the exemplified operation rights here is an example, and it is not specifically limited thereto.

In addition, the plurality of client terminal devices transmit operation information to the server and the server executes the application program according to the operation information transmitted from the client terminal device.

In the example of FIG. 2, the application program is CAD. The screen of the same CAD is displayed between the server and the plurality of client terminal devices.

FIG. 3 is an explanatory diagram illustrating an example of a single server. For example, there is a case where the server is only one, or a case where, even when there are a plurality of servers, a plurality of servers are disposed at the same position, such as a data center. Here, the same position means positions that are almost the same, and the case of the single server includes a case where servers are located only at the same position.

In a case where a server is at the fixed position, there is a case where, for some client terminal devices, the delay by the communication becomes greater and it takes time to display the image. In the example of FIG. 3, since the client terminal device is positioned at a position physically separate from the server and the client terminal device takes time to communicate with the server, the display of the image is delayed. In addition, although a delay by the communication is caused by a physical distance between the server and the device in FIG. 3, the delay changes also in accordance with the degree of congestion of communication or the connecting method of each client terminal device to the network.

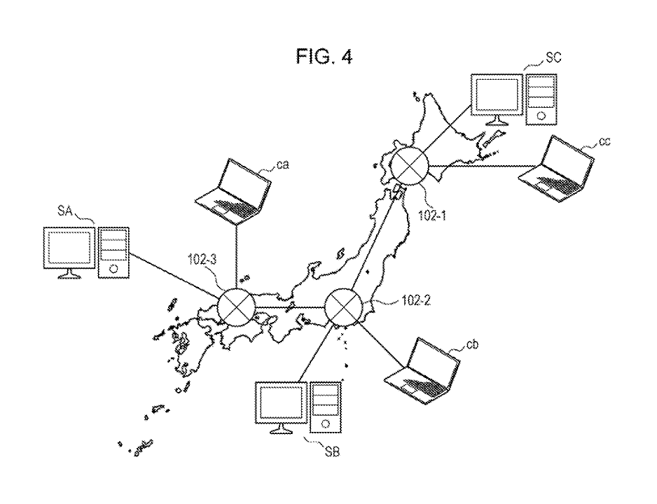

FIG. 4 is an explanatory diagram illustrating an example of a plurality of servers. For example, there is a case where the servers are dispersed and the number of servers is plural. In this case, for example, since the distance between a server and a client terminal device is different for each server, the communication speed of the client terminal device is different for each server.

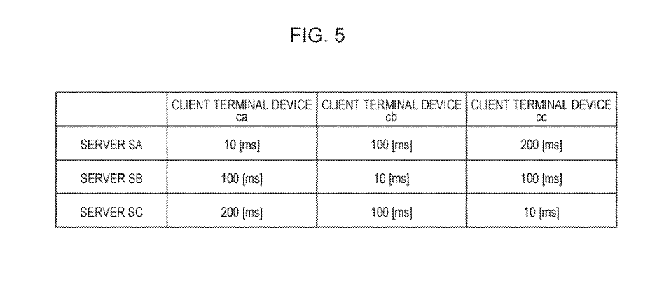

FIG. 5 is an explanatory diagram illustrating an example of different communication speeds. In a table, evaluation values of the communication quality between the client terminal device and the server are indicated for each server. In FIG. 5, as the evaluation value of the communication quality, for example, the delay time is included as described above.

As illustrated in FIG. 5, for example, the client terminal device ca is closer to the server SA. The client terminal device ca is slightly farther from the server SB than the server SA. The client terminal device ca is the farthest from a server SC among the servers SA to SC.

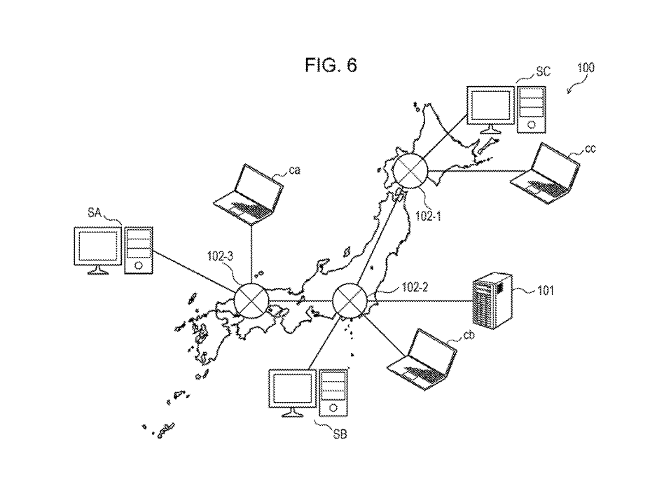

FIG. 6 is an explanatory diagram illustrating an example of a screen sharing system according to the embodiment. In the embodiment, for example, the screen sharing system 100 includes a plurality of servers, a plurality of client terminal devices, and the control device 101.

There exist servers SA to SC. The plurality of servers Si are dispersed and provided in a network constructed in Japan that is a predetermined area. The network 102 includes networks 102-1 to 102-3. The client terminal device is any of client terminal devices ca to cc. As an example of the client terminal device, a mobile terminal device, such as a mobile phone, a personal handy phone (PHS), or a personal digital assistant (PDA), is included in addition to a fixed terminal device such as a PC or the like.

The plurality of servers Si, the plurality of client terminal devices, and the control device 101 are coupled to each other through a network 102-x (x=1 to 3). In the network 102-x, arbitrary types of a communication network, such as the Internet, LAN, a wide area network (WAN), a virtual private network (VPN), may be adopted regardless of whether the network is a wire network or wireless network. The client terminal device cj executes the application program by using any one of the servers Si.

In addition, although not illustrated, the control device 101 may be any one of the servers Si. In addition, although not illustrated, the server Si and the client terminal device cj may be the same computer.

Hardware Configuration Example of Client Terminal Device

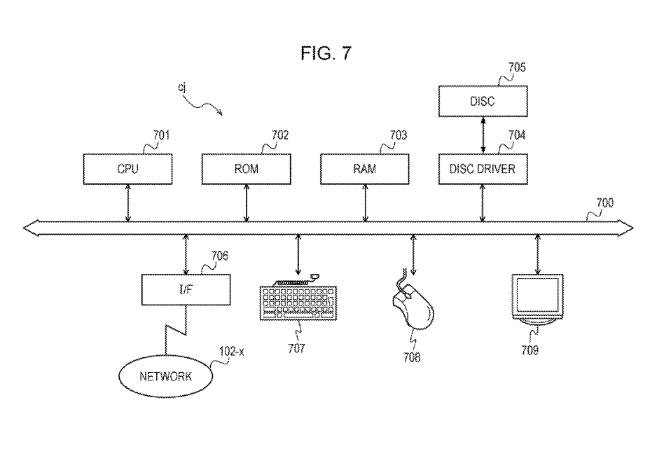

FIG. 7 is a block diagram illustrating an example of a hardware configuration of a client terminal device. The client terminal device cj includes a central processing unit (CPU) 701, a read only memory (ROM) 702, a random access memory (RAM) 703, a disc drive 704, and a disc 705. The client terminal device cj includes an interface (I/F) 706, a keyboard 707, a mouse 708, and a display 709. In addition, the CPU 701, the ROM 702, the RAM 703, the disc drive 704, the I/F 706, the keyboard 707, the mouse 708, and the display 709 are coupled to each other via a bus 700.

Here, the CPU 701 controls the whole of the client terminal device cj. The ROM 702 stores programs such as a boot program. The RAM 703 is used as a work area of the CPU 701. The disc drive 704 controls read/write of data with respect to the disc 705 according to the control of the CPU 701. The disc 705 stores data written in the controlling of the disc drive 704. As the disc 705, a magnetic disk, an optical disc, or the like is included.

The I/F 706 is coupled to the network 102, such as a LAN, a WAN, or the Internet, via the communication line, and coupled to other devices via the network 102. The I/F 706 serves as an interface between the inside of the client terminal device cj and the network 102, and controls the input and output of data to and from an external device. In the I/F 706, for example, a modem or a LAN adaptor may be adopted.

The keyboard 707 and the mouse 708 are interfaces for performing an input of various data items by the operation of the user. The display 709 is an interface for performing an output of data by the instruction of the CPU 701.

In addition, although not illustrated, in the client terminal device cj, an input device for importing an image or a video from a camera or an input device for importing a sound from a microphone may be provided. In addition, although not illustrated, an output device such as a printer may be provided for the client terminal device cj.

Hardware Configuration Example of Server Si

A hardware configuration example of the server Si and the control device 101 will be described. Here, the server Si and the control device 101 are described as a “server or the like”.

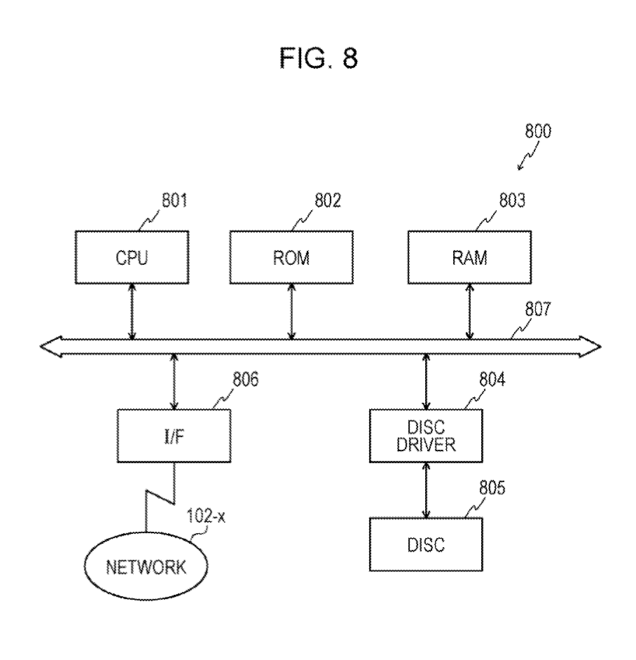

FIG. 8 is a block diagram illustrating an example of a hardware configuration of hardware of a server. The server or the like 800 includes a CPU 801, a ROM 802, a RAM 803, a disc drive 804, a disc 805, and an I/F 806.

The CPU 801, the ROM 802, the RAM 803, the disc drive 804, and the I/F 806 are coupled to each other via a bus 807.

Here, the CPU 801 controls whole of the server or the like 800. The ROM 802 stores various programs. The program to be stored in the ROM 802 is loaded to the CPU 801, and the coded process is executed by the CPU 801. The RAM 803 is used as a work area of the CPU 801.

The I/F 806 is coupled to the network 102 via the communication line, and coupled to other devices via the network 102. The I/F 806 serves as an interface between the inside of the client terminal device cj and the network 102, and controls the input and output of the data to and from an external device. In the I/F 806, for example, a modem or a LAN adaptor may be adopted.

The disc drive 804 controls a read/write of data with respect to the disc 805 according to the control of the CPU 801. The disc 805 stores data written during the control of the disc drive 804. Examples of the disc 805 include a magnetic disk, an optical disc, and the like.

In addition, for example, the server or the like 800 may include a solid state drive (SSD), a keyboard, a mouse, a display, or the like, in addition to the above-described configuration units.

Functional Configuration Example of Screen Sharing System 100

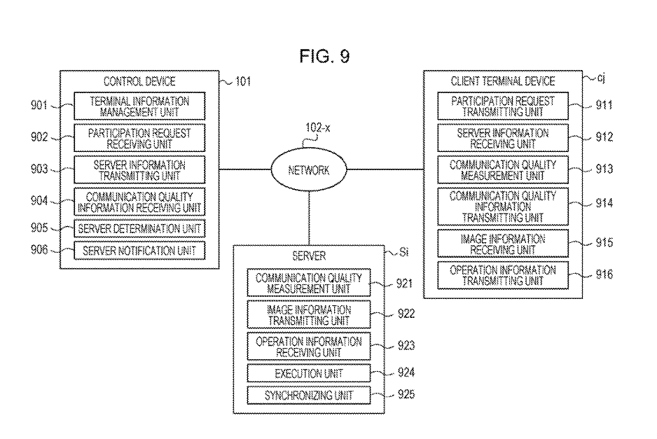

FIG. 9 is a block diagram illustrating an example of a functional configuration of the screen sharing system. The control device 101 includes a terminal information management unit 901, a participation request receiving unit 902, a server information transmitting unit 903, a communication quality information receiving unit 904, a server determination unit 905, and a server notification unit 906. Processes of the control units from the participation request receiving unit 902 to the server notification unit 906 are, for example, coded by a program stored in a storage device such as the ROM 802, the RAM 803, the disc 805, or the like, which are accessible by the CPU 801 illustrated in FIG. 8. The CPU 801 reads the program from the storage device and executes the process coded by the program, thereby realizing the processes of the control units. In addition, the process result of the control unit is, for example, stored in the storage device such as the RAM 803, the disc 805, or the like.

Firstly, the terminal information management unit 901 of the control device 101 manages, for example, information of the server Si participating in the screen sharing system 100. The information of the server Si is connection information used for the client terminal device cj to be coupled to the server Si for screen sharing. In addition, the information of the server Si is, for example, information to be used for measuring the communication quality between the server Si and the client terminal device cj. Specifically, the information of the server Si is, for example, an IP address for each server Si.

The terminal information management unit 901 manages the information of the client terminal device cj participated in the screen sharing. The information of the client terminal device cj is, for example, the IP address for each client terminal device cj. In addition, the terminal information management unit 901 stores various information items to be used when determining the server for executing a target application. The terminal information management unit 901 is realized by, for example, the ROM 802, the RAM 803, the disc 805, or the like. Here, the server Si that performs screen sharing with the client terminal device cj by actually executing the target application is referred to as a screen shared server.

For example, the participation request receiving unit 902 includes a function for receiving a participation request signal indicating a participate request from the client terminal device cj to the screen sharing. The server information transmitting unit 903 includes, for example, a function for transmitting the information of the server Si which is managed by the terminal information management unit 901, to the client terminal device cj having participated in the screen sharing or the client terminal device cj having a participate request. By transmitting the information of the server Si, the control device 101 causes the client terminal device cj to measure the communication quality between the client terminal device cj and the server Si. As for the client terminal device cj participating in the screen sharing or the client terminal device cj having the participate request, the information of each client terminal device cj is managed by the above-described terminal information management unit 901.

The communication quality information receiving unit 904 receives the communication quality information between the client terminal device cj and the server Si from the client terminal device cj. The communication quality information is, for example, information relating to the communication quality.

As described above, the evaluation values of the communication quality includes a two-way communication time for communicating between the server Si and the client terminal device cj, a bandwidth, or a packet loss rate. The two-way communication time is referred to as a delay time. Here, the delay time or the packet loss rate may be measured based on the IP packet to be transmitted from the client terminal device cj to the server Si and a response from the server Si which receives the IP packet from client terminal device cj. For example, the IP packet is generated by a ping command. The bandwidth may be a data amount which is allowed to be communicated for a certain time from the client terminal device cj to the server Si, or may be a data amount which is allowed to be communicated for a certain time from the server Si to the client terminal device cj. The bandwidth may be measured by using a wget command, for example.

The server determination unit 905 determines the server Si for actually executing the target application, based on the communication quality information. The determining method by the server determination unit 905 will be described in detail using Examples 1 and 2 to be described.

The server notification unit 906 notifies each server Si and the client terminal device cj of the determined screen shared server. Specifically, the server notification unit 906 notifies the client terminal device cj of the determination result, based on the information of the client terminal device cj and the information of the server Si managed by the terminal information management unit 901.

More specifically, in a case where the determined screen shared server is the same as the previous screen shared server, the server notification unit 906 notifies the client terminal device cj of the connection information of the determined server Si. In a case where the determined screen shared server is different from the previous screen shared server, the server notification unit 906 notifies the client terminal device cj and all of the servers Si of the connection information of the determined server Si.

The server Si includes a communication quality measurement unit 921, an image information transmitting unit 922, an operation information receiving unit 923, an execution unit 924, and a synchronization unit 925. Processes of the control units from the communication quality measurement unit 921 to the synchronization unit 925 are, for example, coded by a program stored in a storage device such as the ROM 802, the RAM 803, the disc 805, or the like which are accessible by the CPU 801 illustrated in FIG. 8. The CPU 801 reads the program from the storage device and executes the process coded by the program, thereby realizing the processes of the control units. In addition, the process results of the control units are, for example, stored in the storage device such as the RAM 803, the disc 805, or the like.

The communication quality measurement unit 921 operates an operation in coordination with the communication quality measurement unit 921 of the client terminal and acquires the communication quality information between the server Si terminal and the client terminal. The communication quality information is information including the evaluation value of the communication quality. The evaluation value of the communication quality includes an evaluation value of the communication speed such as the reciprocating delay time for communicating or bandwidth, a packet loss rate, or the like. Here, as described above, in the embodiment, the reciprocating time for communicating is used as the evaluation value of the communication quality. For example, the communication quality measurement unit 921 performs response processing in response to the IP packet transmitted from the client terminal device cj. In this case, the IP packet is, for example, an IP packet to be issued by a ping command.

The image information transmitting unit 922 transmits the image information including the image of the screen in accordance with the execution of the target application, to the client terminal device cj. Here, for example, the server Si stores, in the storage device, the information of the client terminal device cj obtained when the communication quality is measured by the communication quality measurement unit 921, and the image information transmitting unit 922 determines a destination address of the image information, based on the information of the client terminal device cj.

The operation information receiving unit 923 receives the operation information from the client terminal device and sends the received operation information to the execution unit. The operation information is information obtained in accordance with the operation of the user with respect to the input device such as the keyboard 707 or the mouse 708.

The execution unit 924 executes the target application. The target application is an application program that is to be a target of the screen sharing. The target application may be a program that is executed in an application layer of the OS and may be the VM that operates on a hypervisor. The target application has to be also executed in the server Si that is a destination to which the screen shared server is moved. Therefore, the target application is provided in advance for all of the servers Si that are candidates for the screen shared server.

In addition, the execution unit 924 executes the target application according to the operation information received by the operation information receiving unit 923.

The synchronization unit 925 transfers a state of the target application of the source server Si that is a current screen shared server, to the destination server Si. Specifically, the synchronization unit 925 transfers the state of the target application by using an application state transition technique (for example, refer to Japanese National Publication of International Patent Application No. 2014-529784), for example. In addition, in a case where the target application is the VM, the synchronization unit 925 transmits the state of the target application by using a live migration technique of the VM.

The client terminal device cj includes a participation request transmitting unit 911, a server information receiving unit 912, a communication quality measurement unit 913, a communication quality information transmitting unit 914, an image information receiving unit 915, and an operation information transmitting unit 916. Processes of the above control units from the participation request transmitting unit 911 to the operation information transmitting unit 916 is, for example, coded by a program stored in a storage device such as the ROM 702, the RAM 703, the disc 705, or the like to which the CPU 701 illustrated in FIG. 7 is accessible. The CPU 701 reads the programs from the storage device and executes the processes coded by the programs, thereby implementing the processes of the control units. In addition, the process results of the control units are, for example, stored in the storage device such as the RAM 703 or the disc 705.

The participation request transmitting unit 911 transmits, to the control device 101, for example, a participate request signal indicating a participate request of a client that has desired to newly participate in the screen sharing. The participation request transmitting unit 911 transmits, for example, the participate request signal via the I/F 706. Here, the participation request signal includes information indicating which one of pieces of the screen sharing the participate request is for, and identification information of the client terminal device cc.

The server information receiving unit 912 receives the information of the server Si from the server information transmitting unit 903 of the control device 101. Here, the client terminal device cj determines that an instruction for measuring the communication quality is received when the information of the server Si is received. In addition, the server information receiving unit 912 receives information on the determined screen shared server from the server notification unit 906 of the control device 101. The server information receiving unit 912 receives various information items via the I/F 706, for example.

Next, the communication quality measurement unit 913 measures the evaluation value of the communication quality between the server Si identified by the received information of the server Si and the corresponding client terminal device cj. Here, a delay is used as the evaluation value of the communication quality. For example, the communication quality measurement unit 913 operates in coordination with the communication quality measurement unit 921 of the server Si, and obtains, for each server Si, the communication quality information indicating the communication quality between the server Si and the corresponding client terminal device cj. The communication quality measurement unit 913 receives the IP packet to each server Si identified by the received information of the server Si, and receives a response in response to the IP packet. In this case, the IP packet is, for example, an IP packet to be issued by a ping command.

Next, the communication quality information transmitting unit 914 transmits communication quality information to the control device 101. The communication quality information transmitting unit 914 transmits the communication quality information via the I/F 706, for example.

In addition, the image information receiving unit 915 receives screen information from the screen shared server. For example, the image information receiving unit 915 receives the screen information via the I/F 706. The client terminal device cj displays the image included in the received screen information.

In addition, the operation information transmitting unit 916 acquires operation information in accordance with the operation which is performed on the screen of the target application, and then transmits the acquired information to the screen shared server. The user performs the operation by using the input device such as the keyboard 707 or the mouse 708, for example.

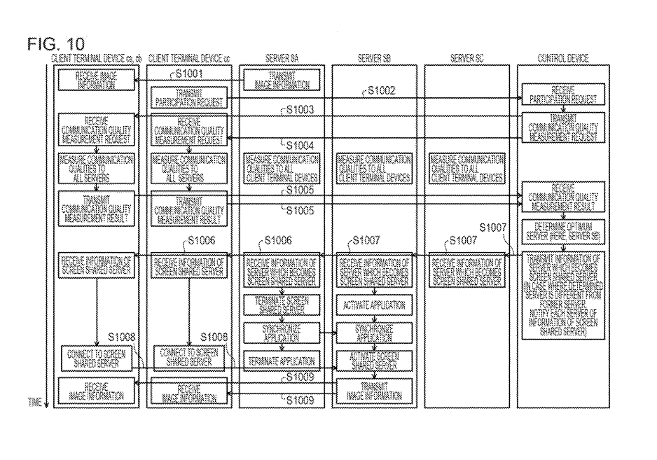

Hereinabove, a brief description of the each function is finished. Next, a flow of all of the operations for each unit will be described with reference to the FIG. 10.

FIG. 10 is a sequence diagram illustrating an example of a process sequence in a case where there is a new participate request for screen sharing from the client terminal device. For example, the client terminal device ca and the client terminal device cb perform screen sharing by causing the server SA to execute the application program.

The image information transmitting unit 922 of the server SA transmits image information including the image of the screen in accordance with the execution of the application program by the execution unit 924 (step S1001).

The image information receiving unit 915 of the client terminal devices ca and cb receive the image information from the server SA, for example. Here, the client terminal devices ca and cb display the image included in the received image information to the display 709 or the like.

In addition, although not illustrated, the operation information transmitting unit 916 of the client terminal device ca or the client terminal device cb transmits operation information in accordance with the operation of the user received via the input device such as keyboard 707 or the mouse 708, to the server SA that is the screen shared server.

The operation information receiving unit 923 of the server SA receives, for example, the operation information from the client terminal device ca or the client terminal device cb.

The execution unit 924 of the server SA executes the application program according to the operation information. As described above, the image information transmitting unit 922 of the server SA transmits the image information including the image of the screen in accordance with the execution of the application program by the execution unit 924. In this manner, the operation information and the image information are transmitted and received during performance of the screen sharing.

Here, the client terminal device cc is newly added to the screen sharing. The participation request transmitting unit 911 of the client terminal device cc transmits a participate request to the control device 101, for example (step S1002). Here, transmitting the participate request means transmitting a participate request signal indicating the participate request. The participation request signal includes information indicating which one of pieces of the screen sharing the participate request is for, and identification information of the client terminal device cc.

The participation request receiving unit 902 of the control device 101 receives the participate request signal indicating the participate request of the client terminal device cc, for example. A determining method of the screen shared server by the server determination unit 905 will be described in detail by using Examples 1 and 2.

The server information transmitting unit 903 of the control device 101 transmits the information of each server Si to the client terminal device cc that has issued the participate request and the client terminal devices ca and cb that are participating to the screen sharing, for example (steps S1003 and S1004). The information of each server Si is managed by the terminal information management unit 901, and the communication quality measurement request is performed.

The server information receiving units 912 of the client terminal devices ca, cb, and cc receive the communication quality measurement request by receiving the information of the server Si from the control device 101, for example. The communication quality measurement units 913 of the client terminal devices ca, cb, and cc measure the communication quality of the communication quality measurement unit 921 of the server Si, based on the information of the server Si.

The communication quality information transmitting units 914 of the client terminal devices ca, cb, and cc transmit the communication quality information that is the communication quality measurement result, to the control device 101 (step S1005).

The communication quality information receiving unit 904 of the control device 101 receives the communication quality information that is the communication quality measurement result, from each client terminal device cj. The server determination unit 905 determines the screen shared server, based on the communication quality information. In the example of FIG. 10, the screen shared server is set at the server SB.

The server notification unit 906 transmits the information of the screen shared server to the client terminal devices ca, cb, and cc, for example (step S1006). In addition, in a case where the server Si determined as the screen shared server is different from the server Si determined as the previous screen shared server, the server notification unit 906 transmits the information of the screen shared server to the servers SA, SB, and SC (step S1007). In addition, in a case where the server Si selected as the screen shared server is the same as the server Si determined as the previous screen shared server, the server notification unit 906 transmits the information of the screen shared server to only the client terminal devices cj.

The server information receiving units 912 of the client terminal devices ca, cb, and cc newly receives the information of the screen shared server, for example. The information of the screen shared server here is an ID of the server Si.

In addition, when the information of the screen shared server is received, since the server SA is the screen shared server before transition, the synchronization unit 925 of the server SA terminates the function as the screen shared server, and synchronizes the application with the server SB that is a new screen shared server. In a case where the synchronization of the application is finished, the execution unit 924 of the server SA terminates the target application.

In addition, since the server SB is a new screen shared server, upon receiving the information of the screen shared server, the execution unit 924 of the server SB activates the target application. Further, since the server SB is the new screen shared server, upon receiving the information of the screen shared server, the synchronization unit 925 of the server SB synchronizes the activated target application with the server SA. When the synchronization is finished, the synchronization unit 925 of the server SB activates the function of the screen shared server.

The client terminal devices ca, cb, and cc are coupled to the server SB that is the screen shared server, based on the received information on the screen shared server (step S1008). The image information transmitting unit 922 of the server SB transmits image information including the image of the screen in accordance with the execution of the target application, to the client terminal devices ca, cb, and cc, for example (step S1009). The image information receiving units 915 of the client terminal devices ca, cb, and cc receive the image information from the image information transmitting unit 922 of the server SB. In this manner, the screen sharing is started.

As described above, the user of each client terminal device cj is able to continue the work in the screen sharing without aware that the screen shared server is switched.

Next, a detailed example by the server determination unit 905 will be described using Examples 1 and 2.

### Example 1

In Example 1, the screen shared server is determined based on the statistic of the delay time for a plurality of combinations between servers Si and client terminal devices cj. Although the delay time is taken as an example of the static in this case, it may be the above-describe bandwidth or the packet loss rate.

Firstly, the server determination unit 905 calculates, for each of the plurality of servers Si, the statistic of the distributions of the evaluation value which is acquired for combinations including the each server among the plurality of servers. The statistic of the distributions of the evaluation value is a mean value or a center value of the evaluation values. The server determination unit 905 determines a server indicating a highest communication quality of the obtained statistic among the plurality of servers Si, to be a server to execute the application program. In a case where the evaluation value is the delay time, the server in which the obtained statistic is minimized is a server indicating the highest communication quality. In a case where the evaluation value is the bandwidth, a server in which the obtained statistic is maximized is a server indicating the highest communication quality. In a case where the evaluation value is a packet loss rate, a server in which the obtained statistic is minimized is a server indicating the highest communication quality.

More specifically, the server determination unit 905 creates a participation client list which is obtained by listing the client terminal devices cj capable of participating in the screen sharing.

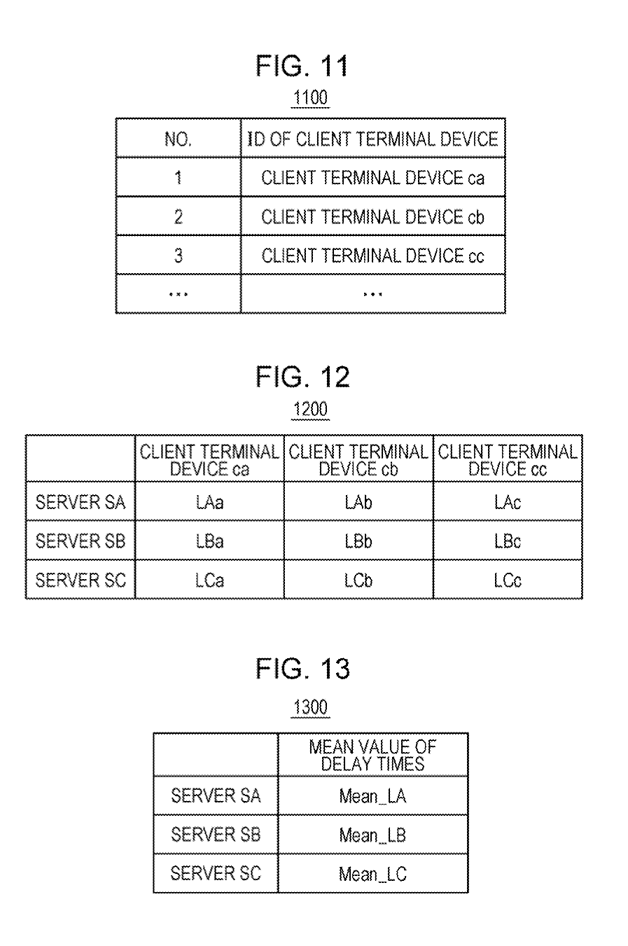

FIG. 11 is an explanatory diagram illustrating an example of a participation client list. In a participation client list 1100, the information of all of the client terminal devices cj capable of participating is registered. The participation client list 1100 includes fields of the number and the IDs of the client terminal devices cj, for example. In the field of the number, a natural number that is incremented in the registered order is set, for example. In the field of the IDs of the client terminal devices cj, identification information for identifying the client terminal device cj is set, for example. The participation client list 1100 may be stored in the storage device such as the RAM 803, and the disc 805.

Next, the server determination unit 905 stores, in a delay time table, the measurement results received by the communication quality information receiving unit 904, for example.

FIG. 12 is an explanatory diagram illustrating an example of a delay time table. In a delay time table 1200, for example, the delay time which is measured for each of the combinations between the client terminal devices cj and the servers Si is stored. The delay time table 1200 is stored in the RAM 803, the disc 805, or the like, for example. For example, the delay time between the server SA and the client terminal device ca is LAa.

The server determination unit 905 notifies a client terminal device, among the plurality of client terminal devices cj, that the client terminal device is not allowed to participate in screen sharing, when the communication quality of the client terminal device, which is obtained from the evaluation values acquired for all of the combinations including the plurality of servers Si, is worse than the predetermined communication quality. A determination whether the communication quality is worse than the predetermined communication quality may be determined by setting a threshold value. For example, in a case where the evaluation value is the delay time, the threshold value is a predetermined time. In a case where the evaluation value is the delay time, when the evaluation value is equal to or greater than the threshold value, it is indicated that the communication quality is worse than the predetermined communication quality, and when the evaluation value is less than the threshold value, it is indicated that the communication quality is better than the predetermined communication quality. In addition, for example, in a case where the evaluation value is the bandwidth, the threshold value is a predetermined bandwidth. In a case where the evaluation value is the bandwidth, when the evaluation value is less than the threshold value, it is indicated that the communication quality is worse than the predetermined communication quality, and when the evaluation value is equal to or greater than the threshold value, it is indicated that the communication quality is better than the predetermined communication quality.

More specifically, for example, the server determination unit 905 determines whether there exists a client terminal device cj among the client terminal devices ca and cb, for which delay times between the client terminal device cj and all of the servers Si set to the delay time table 1200 are equal to or greater than the threshold value. Here, the determination is performed among the client terminal devices ca and cb which are registered to the participation client list 1100. In a case where it is determined that there exists the client terminal device cj whose delay times are equal to or greater than the threshold value, for example, the server determination unit 905 deletes the information of the client terminal device cj from the participation client list 1100. The threshold value here, for example, may be set by a user, a developer, or the like of the screen sharing system 100. The threshold value is, for example, set in accordance with the communication quality required for the client terminal device cj. In addition, the threshold value may be set in accordance with the types of the application program, for example. Here, the threshold value is set at 200 ms, for example.

In this manner, by deleting, from the screen sharing, a client terminal device cj whose communication to any of servers Si coupled to the client terminal device cj is delayed, improvement in the operational feeling of the other users may be achieved. In addition, the server determination unit 905 may display, on each of the client terminal devices cj, an indication that the control device 101 is able to accept an instruction indicating whether to allow a client terminal device cj whose delay time is equal to or greater than the threshold value to participate in the screen sharing or not. In a case where the instruction for allowing the participating, input by the operation of the user, is received through the client terminal devices cj, the server determination unit 905 may avoid deleting the client terminal device cj whose delay time is equal to or greater than the threshold value, from the participation client list 1100. Accordingly, a client terminal device cj whose delay time is equal to or greater than the threshold value may be allowed to participate in the screen sharing only in a case where the other users determine that participating in the screen sharing is permitted even when the operational feeling is deteriorated by any of the client terminal devices cj.

In addition, when the delay time between all of the client terminal devices ca to cc and each server Si is equal to or greater than the threshold value, there is a case where the participation client list 1100 becomes empty. In a case where the participation client list 1100 is empty, the server determination unit 905 displays, on the client terminal device cj, an indication that the quality of the network 102 is not sufficient and it is difficult to share the screen, and the screen sharing is finished. Accordingly, only a case where the quality of the network 102 is equal to or greater than the certain value, the screen sharing may be performed, and the deterioration in the operational feeling of the user may be suppressed.

In addition, there is a case where the participation client list 1100 is not empty. In this case, the server determination unit 905 calculates the statistic of the distributions of the delay time for the client terminal devices cj which are registered in the participation client list 1100, for each of the servers SA to SC, based on the delay time table 1200. The statistic of the distributions of the delay time, for example, includes a mean value, a center value, and a mode value. Here, an example of the mean value will be described.

For example, the server determination unit 905 calculates the mean value of the delay times for the client terminal devices cj which are registered in the participation client list 1100, for each of the servers SA to SC, based on the delay time table 1200. The calculation result of the mean value is stored in a mean delay time table, for example.

FIG. 13 is an explanatory diagram illustrating an example of a mean delay time table. A mean delay time table 1300 stores the mean values of the calculated delay times, for each of the servers Si. For example, the mean delay time of the server SA is a time Mean_LA. The mean delay time of the server SB is a time Mean_LB. The mean delay time of the server SC is a time Mean_LC.

The server determination unit 905 determines a server Si having the most small mean delay time as a screen shared server, based on the mean delay time table 1300. In addition, in a case where there exist plural servers Si having the most small mean delay time, the server determination unit 905 determines a screen shared server, in a random manner, from among the plural servers Si having the most small mean delay time.

In addition, the server determination unit 905 determines whether there exists a client terminal device cj for which a delay time between the client terminal device cj and the determined screen shared server is equal to or greater than the threshold value, among the client terminal devices cj whose information is registered in the participation client list 1100. In a case where it is determines that there is the client terminal device cj having delay time equal to or greater than the threshold value, the server determination unit 905 may determine that the client terminal device cj having delay time equal to or greater than the threshold value is to be deleted from the screen sharing. The control device 101 notifies a client terminal device cj having delay time equal to or greater than the threshold value, that the client terminal device cj is not allowed to participate in the screen sharing. Accordingly, by excluding the client terminal device cj whose communication quality to the determined screen shared server is excessively bad, the communication quality of all of the client terminal devices cj may be improved.

In addition, the screen shared server may be determined after excluding the client terminal device cj whose communication quality is excessively bad. The server determination unit 905 specifies, for each of the plurality of servers Si, a client terminal device whose communication quality, which is indicated by the evaluation value obtained for combinations including the each server Si among the plurality of combinations of the communication quality, is better than the predetermined communication quality. The server determination unit 905 determines a server for which the maximum number of the client terminal devices cj are specified, among the plurality of servers Si, as the screen shared server.

For example, the server determination unit 905 specifies, for each of the plurality of servers Si, a client terminal device cj for which the delay time between the each server Si and the client terminal device cj is not equal to or greater than the threshold value, among client terminal devices cj, as a sharable client terminal device cj, where the client terminal devices cj are client terminal devices cj which are registered in the participation client list 1100. Next, the server determination unit 905 may determine a server Si, for which the maximum number of the sharable client terminal devices cj are specified from among the plurality of servers Si, to be a screen shared server.

In addition, in a case where there exist plural candidate servers for which the maximum number of the sharable client terminal devices cj are specified, the server determination unit 905 calculates, for each of the plural candidate servers, the statistic of the distributions of the evaluation values which are acquired for each of combinations between the specified client terminal devices and the plural candidate servers among the plurality of combinations. The statistic or the calculation method of the statistic is the same as the above-described example. The server determination unit 905 determines a server for which the calculated statistic indicates the highest communication quality among the plural candidate servers, to be a server to execute the application program. A detailed example indicating the highest communication quality is the same as the above-described example.

For example, in a case where there exist plural candidate servers for which the maximum number of the sharable client terminal devices cj are specified, the server determination unit 905 calculates the mean value of the delay times for the specified sharable client terminal devices cj, for each of the servers SA to SC, based on the delay time table 1200. The calculation result of the mean value is stored in the above-described mean delay time table 1300, for example. As described above, the server determination unit 905 determines, based on the mean delay time table 1300, a server Si for which the mean delay time is smallest to be a screen shared server.

In a case where there exist plural servers Si for which the mean delay time is smallest is a plural number, for example, the server determination unit 905 determines, on a random basis, a screen shared server from among the plural servers Si

Accordingly, the screen sharing may be performed by the server Si that improves the communication qualities of all of the client terminal devices cj, while excluding a client terminal device cj for which the communication quality is excessively worse. Accordingly, responsivity for the operation of a user and operational feeling of the user may be improved.

Determining Process Sequence Example of Screen Shared Server by Control Device 101 According to Example 1

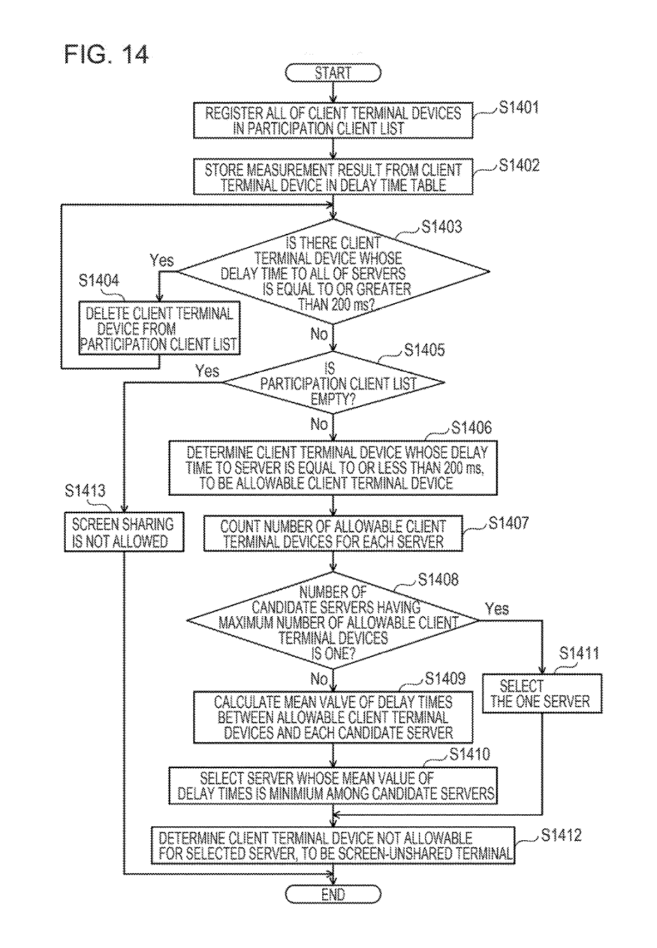

FIG. 14 is an operational flowchart illustrating an example of a determining process sequence of a screen shared server by a control device according to Example 1. The control device 101 registers all of client terminal devices cj that have issued participate requests and client terminal devices cj that are participating in the screen sharing, in the participation client list 1100 (step S1401). The registering a client terminal device cj in the participation client list 1100 means a registration of the information of the client terminal device cj to the participation client list 1100.

Next, the control device 101 stores the measurement results from the client terminal devices cj in the delay time table 1200 (step S1402). The control device 101 determines whether there exists a client terminal device cj whose delay time to all of the servers Si is 200 ms or more, among client terminal devices cj registered in the participation client list 1100 (step S1403). The value of 200 ms is a value which is set as the above-described threshold value.

In a case where there exists a client terminal device cj whose delay time is 200 ms or more (step S1403: Yes), the control device 101 deletes the client terminal device cj whose delay time is 200 ms or more from the participation client list 1100 (step S1404), and the process returns to step S1403. In a case where there exist no client terminal devices cj whose delay time are 200 ms or more (step S1403: No), the control device 101 determines whether the participation client list 1100 is empty (step S1405).

In a case where it is determined that the participation client list 1100 is empty (step S1405: Yes), the control device 101 determines that the screen sharing is not allowed, notifies each client terminal device cj of a screen-unshared notification indicating that each client terminal is not allowed to participate in the screen sharing (step S1413), and a series of process is terminated. In this manner, in a case where the communication quality of all of the client terminal devices cj is worse, it is difficult to share the screen. The difficult in the screen sharing means a case where responsivity for the operation of all the users is worse. In this case, for example, it is difficult to smoothly advance a conference using the screen sharing. Therefore, the screen-unshaded notification may be used as a trigger for improving the communication environment.

On the other hand, in a case where the participation client list 1100 is not empty (step S1405: No), the control device 101 determines a client terminal device cj whose delay time to the server Si is equal to or less than 200 ms, to be an allowable client terminal device cj (step S1406). The control device 101 counts the number of the allowable client terminal devices cj for each server Si (step S1407).

Next, for example, the control device 101 determines whether the number of candidate servers Si for which the number of allowable client terminal devices cj is maximum is one (step S1408). In a case where the number of candidate servers Si for which the number of allowable client terminal devices cj is maximum is one (step S1408: Yes), the control device 101 determines the one server Si for which the number of allowable client terminal devices cj is maximum, to be the screen shared server (step S1411), and the process proceeds to step S1412.

In a case where the number of candidate server Si for which the number of allowable client terminal devices cj is maximum is not one (step S1408: No), the control device 101 calculates a mean value of the delay times of the allowable client terminal devices cj, for each of the candidate servers Si for which the number of allowable client terminal devices cj is maximum (step S1409). The control device 101 selects a server whose mean value of the delay times is minimum among the candidate servers Si for which the number of allowable client terminal devices cj is maximum, and determines the selected server to be the screen shared server (step S1410).

The control device 101 determines that the client terminal device cj, which is not allowable for the determined server Si, is a screen-unshared terminal that is not allowed to participate in the screen sharing (step S1412), and a series process is terminated.

### Example 2

In Example 2, in a case where there exist plural types of evaluation values of the communication quality, each of the evaluation values is scored and the screen shared server is determined based on the total evaluation value. This improves the accuracy of evaluating the communication quality of the server. Further, variation in the communication delay for each client terminal device may be suppressed. Here, examples of the delay time and the bandwidth will be described.

Here, a case where there exist plural types of evaluation values: a first evaluation value and a second evaluation value, will be described. The server determination unit 905 calculates, for each of the plurality of combinations, the total evaluation value of the communication qualities, based on a value obtained by scoring the acquired first evaluation value, and a value obtained by scoring the acquired second evaluation value. The server determination unit 905 calculates, for each of the plurality of servers Si, a total value that is the sum of the calculated total evaluation values. The server determination unit 905 determines a server for which the calculated total value indicates the highest communication quality among the plurality of servers, to be the screen shared server. A detailed example indicating the highest communication quality is the same as the above-described example.

For example, the server determination unit 905 generates the participation client list 1100 by listing the client terminal devices cj that are allowed to participate in the screen sharing. Since an example of the participation client list 1100 is the same as that of Example 1, the detailed description thereof will be omitted.

In the case, a delay time is used as the first evaluation value and a bandwidth is used as the second evaluation value. For example, the server determination unit 905 stores the measurement result which is received from the client terminal device cj in the delay time table 1200 and the bandwidth table. Since an example of the delay time table 1200 is the same as that of the Example 1, the detailed description thereof will be omitted.

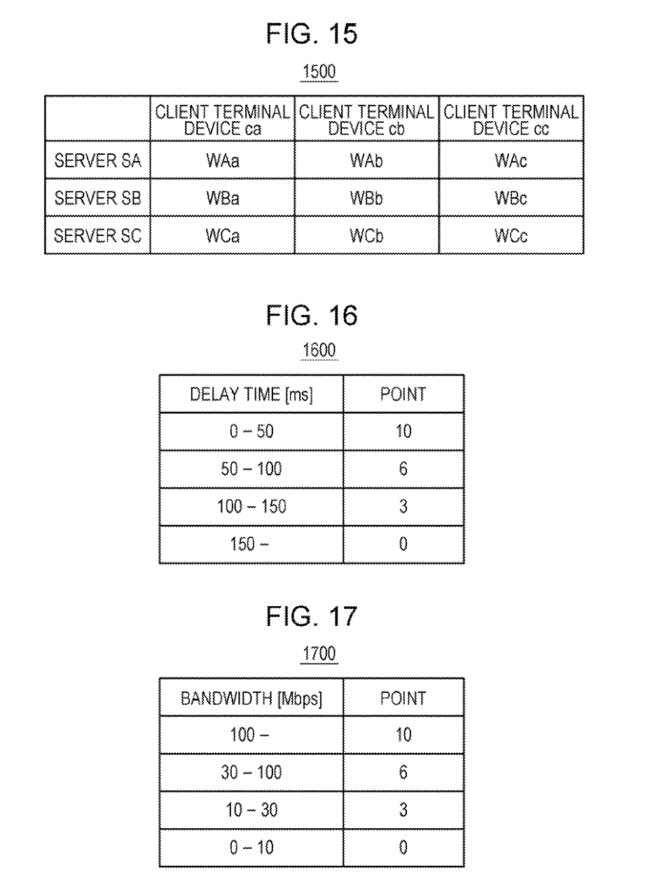

FIG. 15 is an explanatory diagram illustrating an example of a bandwidth table. In a bandwidth table 1500, bandwidths which are measured for the combinations between the client terminal devices cj and the servers Si are stored. For example, the bandwidth table 1500 is stored in the storage device such as the RAM 803, and the disc 805. For example, the bandwidth between the server SA and the client terminal device ca is WAa.

Next, the server determination unit 905 obtains a point corresponding to the delay time which is stored in the delay time table 1200, from a delay time point table.

FIG. 16 is an explanatory diagram illustrating an example of a delay time point table. In a delay time point table 1600, a point is set for each time zone into which the delay time is separated. For example, the delay time point table 1600 is stored in the storage device such as the RAM 803, and the disc 805. Here, as the delay time becomes short, the point becomes higher. For example, when the delay time is 0 to 50 ms, the point is 10. For example, when the delay time is 150 ms or more, the point is 0. In this way, it is possible to represent the first evaluation value as a point.

The server determination unit 905 obtains a point corresponding to the bandwidth which is stored in the bandwidth point table, from a bandwidth point table.

FIG. 17 is an explanatory diagram illustrating an example of a bandwidth point table. In a bandwidth point table 1700, a point is set for each width into which the bandwidth is separated. For example, the bandwidth point table 1700 is stored in the storage device such as the RAM 803, and the disc 805. Here, as a bandwidth becomes greater, a point becomes higher. For example, when the bandwidth is equal to or more than 100 Mbps, the point is 10. For example, when the bandwidth is 0 to 10 Mbps, the point is 0. In this way, it is possible to represent the second evaluation value as a point.

The server determination unit 905 calculates, for each of the combinations between the servers Si and the client terminal devices cj, the total sum of a point corresponding to the delay time and a point corresponding to the bandwidth, as the total evaluation value. Here, the total evaluation value is also referred to as a communication quality point.

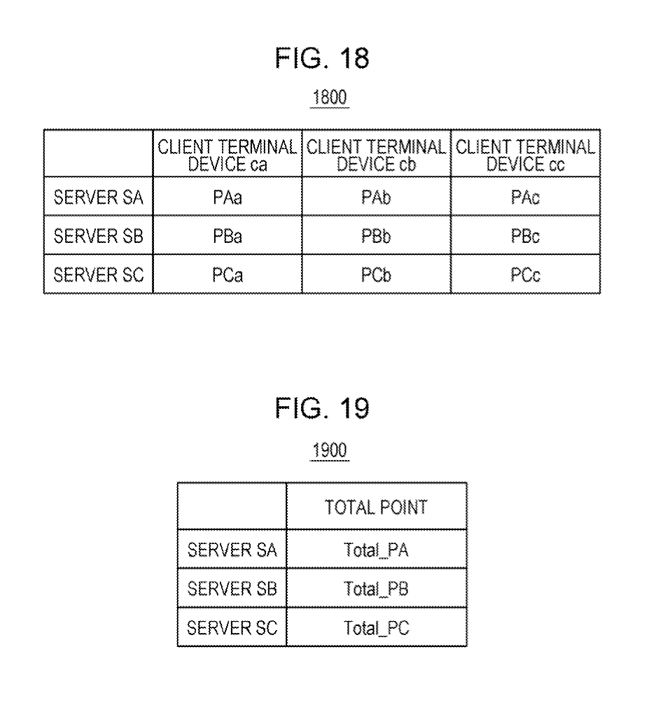

FIG. 18 is a diagram illustrating an example of a communication quality point table. In a communication quality point table 1800, a communication quality point for each of combinations between the servers Si and the client terminal devices cj are set. For example, the communication quality point table 1800 is stored in the storage device such as the RAM 803 and the disc 805. For example, the communication quality point for the combination between the server SA and the client terminal device ca is PAa.

Next, the server determination unit 905 calculates, for each of the plurality of servers Si, a total point of the communication quality points calculated for combinations between the servers Si and the client terminal devices cj.

FIG. 19 is a diagram illustrating an example of a total point table. In a total point table 1900, a total point is set for each of the servers Si. For example, the total point table 1900 is stored in the storage device such as the RAM 803, and the disc 805. For example, the total point for the server SA is Total_PA.

The server determination unit 905 determines a server Si for which the determined total point is maximum, to be the screen shared server. Accordingly, since the server Si whose communication quality becomes good according to the plurality of evaluation values is determined to be the screen shared server, the variations in the response delay may be suppressed, thereby allowing the responsivity for the operation of a user and the operational feeling of the user to be improved.

In addition, the screen shared server may be determined by excluding a client terminal device cj for which the communication quality is excessively worse for all of the servers Si. The server determination unit 905 notifies a client terminal device among the plurality of client terminal devices, for which the total evaluation value, calculated for all of the combinations of the servers among the plurality of combinations, indicates that the communication quality is worse than the predetermined communication quality, of a screen-unshared notification indicating that the screen sharing is not allowed. As described above, as the point becomes higher, the communication quality becomes better. Therefore, when the total evaluation value is equal to or greater than the threshold value, the server determination unit 905 determines that the communication quality is better than the predetermined communication quality, and when the total evaluation value is less than the threshold value, the server determination unit 905 determines that the communication quality is worse than the predetermined communication quality.

In addition, here, the screen shared server may be determined by excluding client terminal devices cj for which the communication quality is excessively worse for all of the servers Si. The server determination unit 905 specifies, for each of the plurality of servers Si, a client terminal device among the plurality of client terminal devices cj, for which the calculated total evaluation value does not satisfy a second condition. The server determination unit 905 determines a server among the plurality of server Si, for which the maximum number of client terminal devices are specified, to be the screen shared server. The second condition is the same as that of the described example.

For example, the server determination unit 905 specifies, for each of the plurality of server Si, a client terminal device cj among the client terminal devices cj, for which the communication quality point is equal to or greater than the predetermined point, to be an allowable client terminal device cj. Here, the client terminal device cj is specified from among the client terminal devices cj which are registered in the participation client list 1100. The predetermined point is a value determined by a user, for example. For example, the predetermined point is 6 points. For example, the server determination unit 905 may determine a server Si among the plurality of servers Si, for which the maximum number of sharable client terminal devices cj are specified, to be the screen shared server.

In addition, in a case where there exist plural candidate servers for which the maximum number of sharable client terminal devices cj are specified, the server determination unit 905 determines a server among the plural candidate servers, for which the total value of the total evaluation values for each of combinations between the plural candidate servers and the specified client terminal devices indicates the highest communication quality among the plurality of combinations, to be the screen shared server. A detailed example indicating the highest communication quality is the same as that of the above-described example.

In addition, in a case where there exist plural candidate servers for which the maximum number of sharable client terminal devices cj are specified, the server determination unit 905 calculates, for each of the plurality of server Si, the total point of the communication quality points calculated for the combination between the each server Si and the sharable client terminal devices cj, based on the communication quality point table 1800. The calculation result of the total point is stored in the above-described total point table 1900, for example. The server determination unit 905 determines, based on the total point table 1900, a server Si whose total point is the maximum value, to be the screen shared server.

This allows a server Si which is capable of suppressing the variations in the communication delay, to be set as the screen shared server. Accordingly, the improvement in the operability of the user may be achieved.

In addition, the server determination unit 905 notifies the client terminal device among the plurality of client terminal devices cj, for which the total evaluation value calculated for the determined screen shared server satisfies the second condition, of the screen-unshared notification. In this manner, by excluding the client terminal device for which the communication quality between the client terminal device and the determined screen shared server is worse from the screen sharing, variation in the communication delay for each client terminal device is suppressed.

Although, in the above-describe example, a case where the evaluation value is the first evaluation value and the second evaluation value was described, a total evaluation value may be obtained by using a point in the same manner in a case where the evaluation value is a third evaluation value. In the case of using the packet loss rate as the third evaluation value, the point table of the packet loss rate may be created such that the point becomes lowered as the packet loss rate becomes higher, in order to conform with the point tables of the above-described example.

Determining Process Sequence Example of Screen Shared Server by Control Device 101 According to Example 2

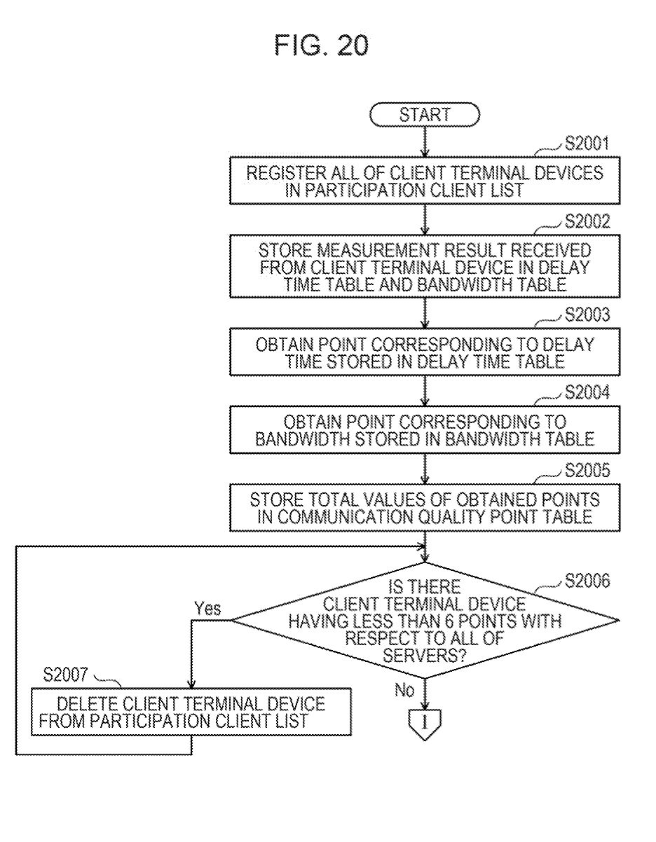

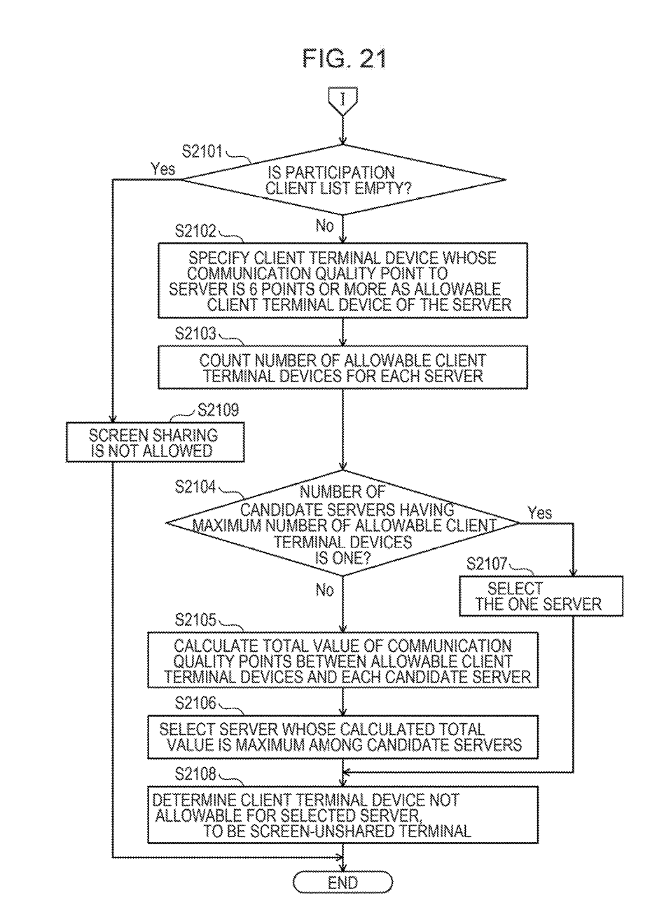

FIGS. 20 and 21 are operational flowcharts illustrating an example of a process sequence of determining a screen shared server by a control device of the screen shared server according to Example 2. The control device 101 registers all of the client terminal devices cj in the participation client list 1100 (step S2001). The control device 101 stores the measurement results which are received from the client terminal devices cj in the delay time table 1200 and the bandwidth table 1500 (step S2002).

The control device 101 obtains the point corresponding to the delay time stored in the delay time table 1200 from the delay time point table 1600, for each of the combinations of the server Si and the client terminal device cj (step S2003). The control device 101 obtains, for each of combinations between the servers Si and the client terminal devices cj, a point corresponding to the delay time stored in the bandwidth table 1500, from the bandwidth point table 1700 (step S2004).

The control device 101 stores the total point of the obtained points in the communication quality point table 1800, for each of the servers Si (step S2005). The control device 101 determines whether there exists a client terminal device cj among the client terminal devices cj registered in the participation client list 1100, for which the communication quality point is less than 6 points for all of the servers Si (step S2006). When there exists a client terminal device cj for which the communication quality point is less than 6 points (step S2006: Yes), the control device 101 deletes the client terminal device cj for which the communication quality point is less than 6 point, from the participation client list 1100 (step S2007), and the process returns to step S2006.

When it is determined that a client terminal device cj for which the communication quality point is less than 6 points is not present (step S2006: No), the control device 101 proceeds to step S2101.

The control device 101 determines whether the participation client list 1100 is empty (step S2101). When it is determined that the participation client list 1100 is empty (step S2101: Yes), the control device 101 determines that the screen sharing is not allowed (step S2109), and the series of process is terminated.

When it is determined that the participation client list 1100 is not empty (step S2101: No), the control device 101 determines a client terminal device cj among the client terminal devices cj registered in the participation client list 1100, whose communication quality point to the server Si is equal to or greater than 6 points, to be the allowable client terminal device cj of the server Si (step S2102). Next, the control device 101 counts the number of the allowable client terminal devices cj for each of the servers Si (step S2103).

The control device 101 determines whether the number of candidate servers Si for which the number of the allowable client terminal devices cj is maximum is one (step S2104). When it is determined that the number of candidate servers Si for which the number of the allowable client terminal devices cj is maximum is one (step S2104: Yes), the control device 101 selects the one server Si for which the number of the allowable client terminal devices cj is maximum, and determines the selected one server Si to be the screen shared server (step S2107), and the process proceeds to step S2108.

When it is determined that the number of candidate servers Si for which the number of the allowable client terminal devices cj is maximum is not one (step S2104: No), the control device 101 calculates the total value of the communication quality points between the allowable client terminal devices cj and each of candidate servers Si for which the number of the allowable client terminal devices cj is maximum (step S2105). The control device 101 selects a server Si for which the total value becomes maximum among the candidate servers Si, and determines the selected server Si to be the screen shared server (step S2106).

Next, the control device 101 determines a client terminal device cj that is not allowable for the determined server Si, to be a screen-unshared terminal that is not allowed to participate in the screen sharing (step S2108), and a series process is terminated. Here, the client terminal device cj that is not allowable for the determined server Si is a client terminal device cj whose communication quality point to the determined server Si is less than 6 points.

As described above, in the screen sharing system 100, a plurality of servers Si are dispersed and provided so that each client terminal device cj participates in the screen sharing. The control device 101 determines a server that implements the screen sharing, based on the evaluation value of the communication quality for each of combinations between the client terminal devices cj and the servers Si. The evaluation value may be a delay time, a bandwidth, or a packet loss rate. This allows a screen shared server to be determined so that the communication quality from each client terminal device cj to the screen shared server is improved, thereby suppressing variation in the communication delay. Accordingly, the operability of the user in the case of using the screen sharing may be improved.

In addition, the control device 101 determines a server for which the statistic of the distributions of the evaluation values for each server indicates the best communication quality, to be the screen shared server. For example, the statistic of the distributions of the evaluation values is the mean value of the evaluation values. Accordingly, since a server whose mean communication quality is best is determined to be the screen shared server, variation in communication delay for each client terminal may further be suppressed.

In addition, the control device 101 specifies, for each server, a client terminal device whose communication quality is not excessively worse, based on the acquired evaluation value, and determines a server for which the number of the specified client terminal devices is maximum, to be the screen shared server. Accordingly, since a server, for which the number of client terminal devices whose communication qualities are excessively worse is small, may be determined to be the screen shared server, variation in communication delay for each client terminal device may further be suppressed.

In addition, in a case where there exist plural candidate servers for which the number of the client terminal devices whose communication qualities are not excessively worse is maximum, the control device 101 determines a server among the plural candidate servers, for which the statistic of the distributions of the evaluation values indicates the highest communication quality, to be the screen shared server. Accordingly, since a server, for which the number of the client terminal devices whose communication qualities are excessively worse is small and the average communication quality is best, may be determined to be the screen shared server, variation in communication delay for each client terminal may further be suppressed.

In addition, the control device 101 notifies a client terminal device among the client terminal devices, whose communication quality for all of the servers is worse, of a screen-unshared notification indicating that the client terminal device is not allowed to participate in the screen sharing. Therefore, screen sharing may be performed excluding a client terminal device whose communication quality is excessively worse, and variation in communication delay for each client terminal device may further be suppressed.

In addition, the control device 101 notifies a client terminal device whose communication quality to the determined server is worse, of the screen-unshared notification. Therefore, screen sharing may be performed excluding a client terminal device whose communication quality is excessively worse, and variation in communication delay for each client terminal device may further be suppressed.

In addition, in a case where there exist plural types of evaluation values, the control device 101 calculates total evaluation values of the communication quality by using a value which is obtained by scoring a first evaluation value and a value which is obtained by scoring a second evaluation value, and determines the screen shared server, based on the total value that is the sum of the total evaluation values. Accordingly, since a server, whose total communication quality is good, is set as the screen shared server, variation in communication delay for each client terminal device may further be suppressed.

In addition, the control device 101 specifies, for each server, a client terminal device whose total evaluation value is not worse, and determines a server for which the number of the specified client terminal devices is largest, to be the screen shared server. Accordingly, since a server, for which the number of client terminal devices whose total communication qualities are excessively worse is small, may be determined to be the screen shared server, variation in communication delay for each client terminal device may further be suppressed.

In addition, in a case where there exist plural servers for which the maximum number of the client terminal devices whose total evaluation values are not worse is the same, the control device 101 determines the screen shared server from the plural servers, based on the statistic that is the sum of the total evaluation values. Accordingly, since a server, for which the number of client terminal devices whose communication quality is excessively worse is small and which has highest communication quality, may be determined to be the screen shared server, variation in communication delay for each client terminal may further be suppressed.

In addition, the control device 101 notifies a client terminal device whose total evaluation values for all of the servers are worst, of the screen-unshared notification indicating the client terminal device is not allowed to participate in the screen sharing. Therefore, screen sharing may be performed with excluding a client terminal device whose communication quality is excessively worse, and variation in communication delay for each client terminal may further be suppressed.

In addition, the control device 101 notifies a client terminal device whose communication quality between the determined server and the client terminal device is worse, of the screen-unshared notification. Therefore, screen sharing may be performed with excluding a client terminal device whose communication quality is excessively worse, and variation in communication delay for each client terminal device may further be suppressed.

The screen sharing method described in the embodiment is realized by executing a screen sharing program which is prepared in advance by a computer such as a personal computer or a work state. This screen sharing program is recoded on a computer-readable recoding medium such as a magnetic disk, an optical disc, or a universal serial bus (USB) flash memory, and executed by reading from the recording medium by a computer. In addition, the screen sharing program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A system to provide screen sharing, the system comprising:
a plurality of servers each including a first processor, the plurality of servers being provided in a network constructed in a predetermined area;
a plurality of client terminal devices each including a second processor configured to display a screen image in accordance with a result of executing an application program that is executed by at least one of the plurality of servers; and
a control device including a third processor configured to control the plurality of servers and the plurality of client terminal devices, wherein
the third processor of the control device executes a control process including:
acquiring, from each of the plurality of client terminal devices, an evaluation value of a communication quality for each of a plurality of terminal-server combinations between the each client terminal and the plurality of servers,
determining, from among the plurality of servers, an objective server to execute the application program, based on the acquired evaluation value, and
transmitting coupling information to be used for communicating with the determined objective server, to the plurality of client terminal devices, and notifying the determined objective server of an execution instruction to execute the application program;
the second processor of a client terminal device executes a client-terminal process of coupling the each client terminal device to the determined objective server among the plurality of servers, based on the received coupling information; and
the first processor of the objective server executes the application program upon receiving the execution instruction.

2. The system of claim 1, wherein
the determining of the control process includes:
calculating, for each of the plurality of servers, a statistic of a distribution of the evaluation values which are acquired for combinations including the each server, among the plurality of terminal-server combinations, and
determining a first server whose communication quality obtained from the calculated statistics is highest among the plurality of servers, to be the objective server.

3. The system of claim 1, wherein,
the control process includes specifying, for each of the plurality of servers, first client terminal devices from among the plurality of client terminal devices, whose communication qualities are higher than a predetermined communication quality, based on the evaluation values which are acquired for combinations including the each server, among the plurality of terminal-server combinations; and
the determining of the control process includes determining a second server among the plurality of servers, for which a number of the specified first client terminal devices is maximum, to be the objective server.

4. The system of claim 3, wherein,
in a case where there exist a plurality of the determined second servers, the third processor of the control device calculates, for each of the plurality of the second servers, a statistic of distribution of the evaluation value which is acquired for each of combinations between the plurality of the second servers and the first client terminal devices among the plurality of terminal-server combinations; and
the determining of the control process includes determining a third server whose communication quality obtained from the acquired statistics is highest among the plurality of the second servers, to be the objective server.

5. The system of claim 1, wherein
the third processor of the control device notifies a first client terminal device among the plurality of client terminal devices, whose communication quality obtained from the evaluation values acquired for combinations including the first server among the plurality of combinations is worse than a predetermined communication quality, of a screen-unshared notification indicating that the first client terminal device is not allowed to participate in the screen sharing.

6. The system of claim 2, wherein
the statistic of distribution of the evaluation values is a mean value of the evaluation values.

7. The system of claim 1, wherein,
in a case where the acquired evaluation values includes plural types of evaluation values including a first evaluation value of the communication quality and a second evaluation value of the communication quality, the control process includes:
calculating, for each of the plurality of terminal-server combinations, a total evaluation value of the communication quality by using a first point value which is obtained by scoring the first evaluation value and a second point value which is obtained by scoring the second evaluation value, and
calculating, for each of the plurality of servers, a total value that is a sum of the calculated total evaluation values; and
the determining of the control process includes determining a first server whose communication quality obtained from the calculated total values is highest among the plurality of servers, to be the objective server.

8. The system of claim 1, wherein,
in a case where the acquired evaluation values includes plural types of evaluation values including a first evaluation value of the communication quality and a second evaluation value of the communication quality, the control process includes:
calculating, for each of the plurality of terminal-server combinations, a total evaluation value of the communication quality by using a first point value which is obtained by scoring the first evaluation value and a second point value which is obtained by scoring the second evaluation value, and
specifying, for each of the plurality of servers, first client terminal devices among the plurality of client terminal devices, whose communication qualities obtained from the calculated total evaluation values are better than a predetermined communication quality; and
the determining of the control process includes determining a first server for which a number of the specified first client terminal devices is largest among the plurality of servers, to be the objective server.

9. The system of claim 8, wherein,
in a case where there is a plurality of the first servers, the third processor of the control device calculates, for each of the plurality of the first servers, a total value that is a sum of the total evaluation values calculated for combinations between the each first server and the second client terminal devices, among the plurality of terminal-server combinations; and
the third processor determines, based on the calculated total value, a second server whose communication quality obtained from the calculated total values is highest among the plurality of the first servers, to be the objective server.

10. The system of claim 7, wherein
the third processor of the control device notifies a first client terminal device among the plurality of client terminal devices, whose communication quality obtained from the total evaluation values calculated for combinations including the second server among the plurality of terminal-server combinations is worse than a predetermined communication quality, of a screen-unshared notification indicating that the first client terminal device is not allowed to participate in the screen sharing.

11. The system of claim 1, wherein
the evaluation value is a time taken for reciprocating communication between a client terminal device and a server for each of the plurality of terminal-server combinations.

12. The system of claim 1, wherein
the evaluation value is a bandwidth of a communication between a client terminal device and a server for each of the plurality of terminal-server combinations.

13. The system of claim 1, wherein
the evaluation value is a packet loss rate at a time of communication between a client terminal device and a server for each of the plurality of terminal-server combinations.

14. A non-transitory, computer-readable recording medium having stored therein a program for causing a computer included in a control device to execute a process, the control device being configured to control a plurality of servers which are provided in a network constructed in a predetermined area, and a plurality of client terminal devices, each of the plurality of client terminal devices being configured to display an image of a screen in accordance with an execution result of an application program executed by at least one of the plurality of servers, the process comprising:
acquiring, from each of the plurality of client terminal devices, an evaluation value of a communication quality for each of a plurality of terminal-server combinations between the each client terminal and the plurality of servers;
determining, from among the plurality of servers, an objective server to execute the application program, based on the acquired evaluation value; and
transmitting information to be used for communicating with the determined objective server, to the plurality of client terminal devices, and notifying the determined objective server of an execution instruction to execute the application program.

15. A method performed by a control device that controls a plurality of servers which are provided in a network constructed in a predetermined area, and a plurality of client terminal devices which display an image of a screen in accordance with an execution result of an application program executed by at least one of the plurality of servers, the method comprising:
acquiring, from each of the plurality of client terminal devices, an evaluation value of a communication quality for each of a plurality of terminal-server combinations between the each client terminal and the plurality of servers;
determining, from among the plurality of servers, an objective server to execute the application program, based on the acquired evaluation value; and
transmitting information to be used for communicating with the determined objective server, to the plurality of client terminal devices, and notifying the determined objective server of an execution instruction to execute the application program.
